(19) United States
(12) Patent Application Publication
(10) Pub. No.: US 2014/0301002 A1
(43) Pub. Date: Oct. 9, 2014

(54) ESD PROTECTION MATERIAL AND ESD PROTECTION DEVICE USING THE SAME

(71) Applicant: Samsung Electro-Mechanics Co., Ltd., Suwon-si (KR)

(72) Inventors: Hong Ryul LEE, Suwon-si (KR); Kang-Heon Hur, Suwon-si (KR); Sang Moon Lee, Suwon-si (KR); Young Do Kweon, Suwon-si (KR); Young Seuck Yoo, Suwon-si (KR)

(73) Assignee: Samsung Electro-Mechanics Co., Ltd., Suwon-si (KR)

(21) Appl. No.: 14/248,041

(22) Filed: Apr. 8, 2014

(30) Foreign Application Priority Data
Apr. 9, 2013 (KR) 10-2013-0038691

(51) Int. Cl. H02H 9/04; H01B 1/22

(52) U.S. Cl. CPC H02H 9/044; H01B 1/22
USPC 361/56; 252/512; 252/513; 252/514

(57) ABSTRACT

Disclosed herein are an electrostatic discharge protection material for improving connectivity between conductive particles dispersed in a resin matrix and evenly distributing the conductive particles in the resin material, and an electrostatic discharge protection device using the same. The electrostatic discharge protection material includes a resin matrix; needle-shaped conductive particles dispersed in the resin matrix; and dispersion particles dispersed in the resin matrix, wherein the dispersion particles are located between the needle-shaped conductive particles.

### CROSS REFERENCE(S) TO RELATED APPLICATIONS

This application claims the benefit under 35 U.S.C. Section 119 of Korean Patent Application Serial No. 10-2013-0038691, entitled “ESD Protection Material and ESD Protection Device Using The Same” filed on Apr. 9, 2013, which is hereby incorporated by reference in its entirety into this application.

### BACKGROUND OF THE INVENTION

1. Technical Field

The present invention relates to an electrostatic discharge protection device, and more particularly, to a particle structure of an electrostatic discharge protection material included in an electrostatic discharge protection device.

2. Description of the Related Art

Recently, as electronic devices such as mobile phones are reduced in size and become highly functional, high speed transmission (at high frequency over 1 GHz) is rapidly being developed, as is represented by USB 2.0, USB 3.0 and S-ATA2, HDMI, etc. In return, the voltage resistance of the electronic devices are getting lower, and, accordingly, it becomes important to protect electronic devices from electrostatic pulses generated when a human body and terminals of the electronic devices are brought into contact.

In order to protect electronic devices from the electrostatic pulses, it is common to connect an electrostatic discharge protection devices (hereinafter referred to as an ESD protection device) between a line through which static electricity comes in and ground.

In the Patent Document referenced below, a conventional ESD protection device has the structure in which electrostatic protection material (hereinafter referred to as ESD protection material) is filled between a pair of electrodes facing each other and the ESD protection material includes various types of conductive particles dispersed in an insulative resin matrix.

In this configuration, in a normal operation state with no electrostatic pulse, the resistance between the electrodes is infinite so that no current flows therebetween, and a normal input signal flows into an electronic device. However, if an over voltage is applied due to static electricity, electric tunneling occurs that a conductive path is formed between conductive particles and current flows between the pair electrodes. By doing so, the current due to the over voltage bypasses the electronic device and flows to ground via the ESD protection device, and thus the electronic devices may be protected from the over voltage.

In forming conductive paths, distances between conductive particles dispersed in a resin matrix or the number of contact points (here, the contact points may include a point which is not in contact but at the shortest distance, as well as a point in actual contact) are important factors.

### RELATED ART DOCUMENT

### Patent Document

(Patent Document 1) Japanese Patent Laid-Open Publication No. 2010-165660

### SUMMARY OF THE INVENTION

An object of the present invention is to provide an electrostatic discharge (ESD) protection device with an improved voltage resistance characteristic on static electricity and so on.

According to an exemplary embodiment of the present invention, there is provided an electrostatic discharge protection material, including: a resin matrix; needle-shaped conductive particles dispersed in the resin matrix; and dispersion particles dispersed in the resin matrix, wherein the dispersion particles are located between the needle-shaped conductive particles.

The dispersion particles may have a circle shape.

A content ratio of the dispersion particles may be between 15 Vol % and 45 Vol %.

A diameter of the dispersion particles may be between 100 nm and 500 nm.

The dispersion particles may include different types of particles having different dimensions.

The dispersion particles may be made of non-conductive inorganic material.

The dispersion particles may be made of at least one type of material selected from a group consisting of Al₂O₂, SiO₂, TiO₂, ZnO, In₂O₃, NiO, CoO, SnO₂, ZrO₂, CuO, MgO, AlN, BN and SiC or a combination thereof.

A length of a major axis of the conductive particles may be between 1 μm and 15 μm, and a length of a minor axis may be between 50 nm and 500 nm.

The conductive particles may be made of at least one type of metal selected from a group consisting of C, Ni, Cu, Au, Ti, Cr, Ag, Pd and Pt, or a combination thereof.

According to another exemplary embodiment of the present invention, there is provided an electrostatic discharge protection device, including: an insulating substrate; a pair of electrodes disposed on the insulating substrate spaced apart and facing each other; and a functional layer disposed over the insulating substrate and covering an area between the electrodes, wherein the functional layer is made of the electrostatic discharge protection material described above.

### BRIEF DESCRIPTION OF THE DRAWINGS

FIG. 1 is a cross-sectional view of an ESD protection device according to an exemplary embodiment of the present invention;

FIG. 2 is a plan view of the ESD protection device according to the exemplary embodiment of the present invention; and

FIG. 3 are enlarged views of conductive particles and dispersion particles included in the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. The components, steps, operations and/or elements stated herein do not exclude the existence or addition of one or more other components, steps, operations and/or elements.

Hereinafter, a configuration and an acting effect of exemplary embodiments of the present invention will be described in more detail with reference to the accompanying drawings.

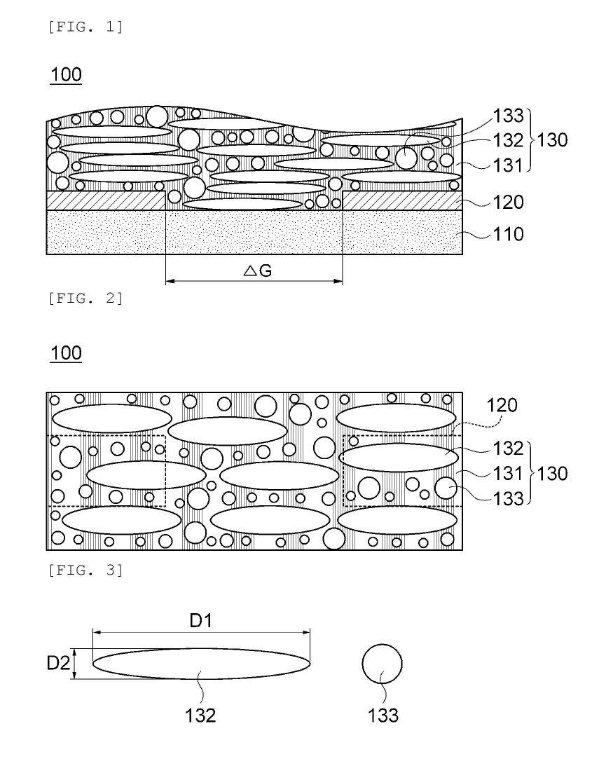

FIG. 1 is a cross-sectional view of an ESD protection device according to an exemplary embodiment of the present invention; and FIG. 2 is a plan view of the ESD protection component according to the exemplary embodiment of the present invention. Additionally, components shown in the accompanying drawings are not necessarily shown to scale. For example, sizes of some components shown in the accompanying drawings may be exaggerated as compared with other components in order to facilitate the understanding of the exemplary embodiments of the present invention.

Referring to FIG. 1, the ESD protection device 100 according to the exemplary embodiment may include an insulating substrate 110, a pair of electrodes 120 formed on a surface of the insulating substrate 110, and a functional layer 130 provided over the surface of the insulating substrate 100 so as to cover the area between the pair of electrodes 120.

The insulating substrate 110 is not limited to a particular substrate as long as it supports the pair of electrodes 120 and the functional layer 130. Further, the dimensions and shapes are not specifically limited, but may be variously manufactured depending on electronic devices to which the ESD protection device 100 of the present invention is applied.

The insulating substrate 110 is not limited to a particular substrate as long as it has an insulative surface on which the pair of electrode 120 and the functional layer 130 are formed. Accordingly, the insulating substrate 110 not only includes a substrate made of an insulative material but also includes a substrate of which some or all surfaces have an insulating film.

Specifically, the insulating substrate 100 may be a ceramic substrate such as alumina, silica, magnesia, aluminum nitride, and forsterite or a monocrystal substrate. In addition, a ceramic substrate or a monocrystal substrate on which an insulating film of alumina, silica, magnesia, aluminum nitride, forsterite, and so on is formed may be preferably used.

The pair of electrodes 120 are spaced apart from each other, and are formed on a surface of the insulating substrate 110 facing each other. In the exemplary embodiment, the pair of electrodes 120 are formed on a center potion of the insulating substrate 110, facing each other with a gap distance ΔG therebetween. The gap distance ΔG may be appropriately determined based on a desired discharge characteristic, and is typically between about 1 o 50 μm.

The material of the pair of electrodes 120 may include at least one metal selected from a group consisting of C, Ni, Al, Fe, Cu, Ti, Cr, Au, Ag, Pd and Pt, or the combination thereof; but the present invention is not limited thereto. Further, in the exemplary embodiment, the pair of electrodes 120 have a rectangular shape. However, the present invention is not limited thereto but may have other shapes such as a comb shape or a saw tooth shape.

The functional layer 130 of an ESD protection material may be formed between the pair of electrodes 120. The functional layer 130 may be formed by performing sputtering, deposition or screen printing on a surface of the insulating substrate 110 including the area between the pair of electrodes 120, with an ESD protection material made of a paste type.

The dimensions or shape of the functional layer 130 are not specifically limited as long as it ensures that initial discharge occurs through the functional layer 130 itself between the pair of electrodes 120 when over voltage is applied. Additionally, although the thickness of the functional layer 130 is not specifically limited, in order to achieve a smaller size and higher performance of an electronic device using the ESD protection device of the present invention, the thickness is desirably between about 10 nm and 10 μm.

The ESD protection material, which forms the functional layer 110, is formed with needle-shaped conductive particles 132 and dispersion particles 133 dispersed in an insulative resin matrix 131.

The resin material used for the matrix of the ESD protection material may include a polymer material such as an epoxy resin, a phenol resin, an urethane resin, a silicon resin and a polyimide resin. One type of material may be solely used, or two or more types of materials may be used in combination.

FIG. 3 is an enlarged view of a conductive particle 132 and a dispersion particle 133. Referring to FIG. 3, the conductive particle 132 may be made of at least one metal from a group consisting of C, Ni, Cu, Au, Ti, Cr, Ag, Pd and Pt, or a combination thereof. The length of the long axis D1 ranges from 1 μm to 15 μm, and the length of the shorter axis D2 ranges from 50 nm to 500 nm so that the conductive particle 132 may have a needle shape.

If the conductive particle 132 has a circle shape other than a needle shape, the contact area between the particles would be dot-like shape. According to the present invention in which the particle has a needle shape, however, the contact area between the particles would be surface-like shape, such that the contact area between the conductive particles 132 would be noticeably increased (here, the contact area may include a point which is not in contact but at the shortest distance, as well as a point in actual contact). As a result, conductive paths are multiplied when over voltage is applied so that the performance of ESD protection device, which is represented by electrostatic voltage resistance, may be greatly enhanced.

In order to obtain paste-type ESD protection material, however, conductive particles, resins and other organic solvent need to be weighted and milled using a ball mill or a roll mill and the like at a predetermined ratio. During these processes, attraction force between needle-shaped conductive particles 132 (specifically, Van Der Waals' force) is increased as much as contact points between the particles are increased. As a result, the needle-shaped conductive particles 132 agglomerate so that they are not evenly distributed in a resin matrix.

According to the present invention, in the process of milling, the needle-shaped conductive particles 132 are mixed with the dispersion particles 133, such that the ESD protection material may be used which has the structure in which the dispersion particles 133 are located between the needle-shaped conductive particles 132.

Locating the dispersion particles 133 between the needle-shaped conductive particles 132 degrades the interface property of the conductive particles 132 and consequently suppresses agglomeration of the conductive particles 312, such that the needle-shaped conductive particles 132 may be evenly distributed in the resin matrix.

Here, the dispersion particles 133 is preferably made of inorganic material in order to obtain insulation between the conductive particles 132 as well as the distribution. The specific example of the inorganic material may include at least one type of material selected from the group consisting of Al₂O₃, SiO₂, TiO₂, ZnO, In₂O₃, NiO, CoO, SnO₂, ZrO₂, CuO, MgO, AlN, BN and SiC, or a combination thereof.

In order to facilitate the dispersion particles 133 to be located between the need-shaped conductive particles 132, the dispersion particles 133 preferably have a circle shape.

Additionally, since it is difficult to disperse the conductive particles 132 if the dimensions of the dispersion particles 133 are too large or too small than those of the conductive particles 132, it is desirable that the diameter of the dispersion particles 133 are determined within an appropriate range by taking into account the lengths of major and minor axes of the conductive particles 132. For instance, the diameter of the conductive particles 132 may range from 100 nm to 500 nm.

Further, within the range, the dispersion particles 133 may include two, three or more types of particles having different dimensions. By doing so, micro particles are filled between coarse particles so that a higher number of dispersion particles may be located in the space between the needle-shaped conductive particles 132, and thereby further suppressing the conductive particles 132 from agglomerating.

The content ratio of the dispersion particles 133 is set within the range from 15 Vol % to 45 Vol %.

If the content ratio of the dispersion particles 133 is less than 15 Vol %, it is difficult to suppress the agglomeration of the conductive particles 132, and the insulation resistance may be lowered. To the contrary, if the content of the dispersion particles 133 exceeds 45 Vol %, the distance between the conductive particles 132 becomes distant, such that the threshold voltage to cause the electron tunneling, i.e., the clamp voltage is increased and thus it may loose the function of an ESD protection device.

Accordingly, the content ratio of the dispersion particles 133 is appropriately chosen within the numerical range. However, since the above numerical range is the optimal value to maximize the effect of the present invention, a value slightly deviated from the numerical range may be allowable as long as it meets the purpose of the present invention.

As stated above, according to the present invention, needle-shaped conductive particles are dispersed in a resin matrix, such that connectivity between the conductive particles (here, the connectivity refers to an electric connection through a conductive path) are improved, and thus static electricity can be further prevented.

Further, by providing a structure in which dispersion particles are located between needle-shaped conductive particles, the agglomeration of the conductive particles can be prevented, such that the needle-shaped conductive particles are evenly distributed in the resin matrix, thereby achieving more stable conduction characteristic.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

1. An electrostatic discharge (ESD) protection material, comprising:
a resin matrix;
needle-shaped conductive particles dispersed in the resin matrix; and
dispersion particles dispersed in the resin matrix,
wherein the dispersion particles are located between the needle-shaped conductive particles.

2. The material according to claim 1, wherein the dispersion particles have a circle shape.

3. The material according to claim 1, wherein a content ratio of the dispersion particles is between 15 Vol % and 45 Vol %.

4. The material according to claim 1, wherein a diameter of the dispersion particles is between 100 nm and 500 nm.

5. The material according to claim 1, wherein the dispersion particles include different types of particles having different dimensions.

6. The material according to claim 1, wherein the dispersion particles are made of non-conductive inorganic material.

7. The material according to claim 1, wherein the dispersion particles are made of at least one type of material selected from a group consisting of Al₂O₃, SiO₂, TiO₂, ZnO, In₂O₃, NiO, CoO, SnO₂, ZrO₂, CuO, MgO, AlN, BN and SiC or a combination thereof.

8. The material according to claim 1, wherein a length of a major axis of the conductive particles is between 1 μm and 15 μm, and a length of a minor axis is between 50 nm and 500 nm.

9. The material according to claim 1, wherein the conductive particles are made of at least one type of metal selected from a group consisting of C, Ni, Cu, Au, Ti, Cr, Ag, Pd and Pt, or a combination thereof.

10. An electrostatic discharge protection device, comprising:
an insulating substrate;
a pair of electrodes disposed on the insulating substrate spaced apart and facing each other; and
a functional layer disposed over the insulating substrate and covering an area between the electrodes,
wherein the functional layer is made of the electrostatic discharge protection material according to claim 1.
